(19) United States
(12) Patent Application Publication
(10) Pub. No.: US 2022/0361518 A1
(43) Pub. Date: Nov. 17, 2022

(54) LIQUID PLANT-BASED CREAMER AND/OR WHITENER COMPOSITIONS AND PROCESSES OR PREPARING THE SAME

(71) Applicant: WhiteWave Services, Inc., Broomfield, CO (US)

(72) Inventors: Pulari Krishnankutty Nair, Erie, CO (US); Luke Michael Chavez, Denver, CO (US)

(21) Appl. No.: 17/662,723

(22) Filed: May 10, 2022

Related U.S. Application Data
(60) Provisional application No. 63/186,939, filed on May 11, 2021.

(51) Int. Cl. A23C 11/10; A23J 3/14

(52) U.S. Cl. CPC A23C 11/103; A23J 3/14

(57) ABSTRACT

The present embodiments relate to plant-based liquid creamers and/or whiteners and processes for the preparation and use thereof.

### CROSS REFERENCE TO RELATED APPLICATIONS

This application claims priority to provisional patent application Ser. No. 63/186,939, filed May 11, 2021 and entitled LIQUID PLANT-BASED CREAMER AND/OR WHITENER COMPOSITIONS AND PROCESSES OF PREPARING THE SAME, the entire contents of which are incorporated herein by reference.

### FIELD OF THE INVENTION

The invention generally relates to plant-based liquid creamer and/or whitener compositions and a process to prepare the same. More specifically, the present disclosure is directed to liquid creamer and/or whitener compositions that contain low amounts of additives, have good organoleptic characteristics and good shelf-life at ambient temperatures.

### BACKGROUND OF THE INVENTION

Plant-based coffee creamers and whiteners are well known in the art.

Typically such products comprise a fat base (e.g. coconut cream), a pH modifier that helps to prevent protein precipitation (e.g. baking soda), an emulsifier (typically lecithin), an emulsion stabilizer (e.g. gums), flavorings and optionally sweeteners.

Plant-based creamer products, are typically either chilled or shelf-stable at ambient temperatures. Typically, liquid plant-based creamers have relatively long ingredient lists and include multiple additives for stabilizing the product, both during shelf-life and when added to coffee. Feathering or coagulation of the creamer is a problem when added to coffee, and sedimentation or separation during shelf-life is another problem that requires the use of multiple additives such as emulsifiers (e.g. lecithin), thickeners (e.g. various gums) and stabilizers. These problems are especially pronounced in liquid shelf-stable products, which are required to have a relatively long shelf life at ambient temperatures as compared to chilled alternatives. This can be seen from the relatively long ingredient lists of such products.

In order to address these problems, liquid shelf-stable creamers are typically based on coconut cream, as it is a readily sourced emulsion that does not have such an issue with separation during shelf life. However coconut cream has a pronounced characteristic flavor and does not provide a good base for a neutral or flavored product.

WO2017216194 provides a liquid creamer formulation suitable for storage under refrigerated conditions. It is based on coconut cream but also includes low amounts of coconut oil and plant protein. However, high amounts of coconut cream, 2 types of gums and dipotassium phosphate are required to ensure a stable product.

WO2019122336 provides a “clean label” creamer formulation based on coconut oil and plant protein. However, this is a powdered formulation, so it does not have the same challenges of sedimentation during shelf life. Also, to achieve this, it uses plant proteins with a relatively small size that are typically hydrolyzed proteins. Hydrolyzed proteins are good emulsifying agents but have characteristic bitter tastes. From the Examples in WO2019122336, it seems that low molecular weight and high molecular weight proteins did not work and that a specific median range of from 800 to 20,000 Daltons was required along with the need of an additional emulsifying agent required (lecithin).

WO201968590 provides a liquid creamer formulation whose storage is described as being stable under refrigerated conditions. It is based on coconut oil and plant protein.

Therefore, a need exists for a composition that overcomes one or more of the current disadvantages noted above.

### BRIEF SUMMARY OF THE INVENTION

The present embodiments surprisingly provide shelf-stable neutral tasting clean label plant-based liquid creamer and/or whitener formulations based on coconut oil with plant protein as the emulsifying agent and only requires the use of a single emulsion stabilizing agent, for example, gellan gum.

It has been discovered, as disclosed herein, that by reducing particle size of a plant-based liquid creamer and/or whitener composition comprising a) water, b) a vegetal oil, c) a plant protein and d) a buffering agent and limiting the plant protein content to only that required for emulsification, a shelf stable product having good taste and texture can be made using only a single emulsion stabilizing agent. Suitable plant-based liquid creamer and/or whitener compositions include 40-90% w/w water; 5-15% w/w a vegetal oil; 0.0001-5% w/w a plant protein; and 0.0001%-5% w/w a buffering agent; optionally, 0-5% w/w a nut base composition; optionally, 0-1% w/w a hydrocolloid agent; optionally, 15-35% w/w a sweetening agent; optionally, 0.0001-5% w/w a flavor modification agent, wherein the particle size particle size distribution of the composition has at least 90% or greater, particles with a maximum dimension equal to or less than 2 μm.

When oil content is decreased, there can be excess emulsifiers (protein) in the system. Not to be bound by theory, it is speculated that with increasing protein concentration, the size of particles decrease until a particular threshold is reached. Since most of the oil particles were completely coated by the emulsifier, the excess protein may aggregate amongst itself to make larger particles which is not desirable and can result in an unstable emulsion.

In a first aspect, the present embodiments provide plant-based liquid creamers and/or whitener compositions.

In a second aspect, the present embodiments provide processes for the preparation of plant-based liquid creamers and/or whitener compositions.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 depicts particle size distribution of the emulsion of Example 1.

FIG. 2 depicts particle size distribution of creamer shelf life of Example 2B.

FIG. 3 depicts a bimodal particle size distribution of Example 3.

FIG. 4 depicts particle size distribution of Example 6 when a faba bean protein isolate was utilized.

### DETAILED DESCRIPTION

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

As used herein, the term “ppm” shall be taken to mean “parts per million”. One gram in 1 liter is 1000 ppm and one thousandth of a gram (0.001 g) in 1 liter is one ppm.

As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

In the context of this application, unless otherwise provided, amounts refer to amounts by weight.

As used herein the term “plant-based” shall be taken to mean a composition or product which comprises plant or plant-derived matter but does not comprise animal or animal-derived matter including but not limited to dairy, egg, fish, shellfish, meat, dairy milk and insects.

As used herein the adjective “dairy” shall be taken to mean a composition or product comprises or consists of mammalian milk matter, i.e. the lacteal secretion obtainable by milking.

As used herein the terms “free” or “free from” shall be taken to mean a composition or product which preferably does not contain a given substance but where trace amounts or contaminants thereof may be present.

As used herein the terms plant-based alternative, analogue or substitute shall be taken to mean a plant-based food or beverage composition that is formulated to simulate the organoleptic and/or nutritional qualities of an equivalent nonplant-based product.

### Plant-Based Liquid Creamer and/or Whitener Compositions

In a first aspect, the present embodiments provide plant based liquid creamers and/or whitener compositions.

Accordingly, embodiments described herein provide compositions comprising a) water, b) vegetal oil(s), c) plant protein(s) and d) buffering agent(s).

The compositions described herein may optionally further comprise e) nut composition(s), f) hydrocolloid agent(s), g) sweetening ingredients and/or h) flavor modification agents.

In the embodiments described herein, the stable compositions are oil in water emulsions.

In one embodiment, the stable compositions are substantially free of lecithin. In another embodiment, the stable compositions are free of lecithin. Should the composition comprise a minor amount of lecithin, this amount is less than 0.1% by weight, for example, less than 0.05%, for example, less than 0.01%, for example, less than 0.005%, for example, less than 0.001%.

In one embodiment, the stable compositions are substantially free of soy lecithin. In another embodiment, the stable compositions are free of soy lecithin. Should the composition comprise a minor amount of soy lecithin the amount is less than 0.1% by weight, for example, less than 0.05%, for example, less than 0.01%, for example, less than 0.005%, for example, less than 0.001%.

In still another embodiment, the stable compositions are substantially free of sunflower lecithin. In another embodiment, the stable compositions are free of sunflower lecithin. Should the composition comprise a minor amount of sunflower lecithin the amount is less than 0.1% by weight, for example, less than 0.05%, for example, less than 0.01%, for example, less than 0.005%, for example, less than 0.001%.

In yet another embodiment, the stable compositions are substantially free of rapeseed lecithin. In another embodiment, the stable compositions are free of rapeseed lecithin. Should the composition comprise a minor amount of rapeseed lecithin the amount is less than 0.1% by weight, for example, less than 0.05%, for example, less than 0.01%, for example, less than 0.005%, for example, less than 0.001%.

Consumers are looking for more plant-based food products with minimal ingredients for various reasons like personal health, life style, ethics, and sustainability. It is believed that removal of lecithin leads to reduced emulsion stability, which negatively affects overall composition stability, whitening and/or organoleptic properties. The functional attributes of lecithin is attributed to its low molecular weight and high hydrophilic lipophilic balance that makes it a very functional at the oil-water interface. A number of alternatives were screened like acacia gum or a combination of plant proteins with acacia gum as a replacer for lecithin. However these trials weren't successful as it led to emulsion instability or the rates of usage is exceptionally high so that it significantly impacted the flavor and mouthfeel of the finished product. Therefore, it is surprising and advantageous that the compositions described herein are shelf stable and/or do not require refrigeration without the need of significant levels of lecithin(s) to provide stability as required with creamer/whitening compositions that are currently available.

In one embodiment, the stable compositions are substantially free of coconut cream. In one embodiment, the stable compositions are free of coconut cream. Should the composition comprise a minor amount of coconut cream this amount is less than 0.1% by weight, for example, less than 0.05%, for example, less than 0.01%, for example, less than 0.005%, for example, less than 0.001%.

In one embodiment, the stable compositions are substantially free of dipotassium phosphate. Increasing consumer demand for food and beverage products containing natural ingredients is a major trend in the food industry. There is a demand for “clean-label foods” without adding ingredients that sound “chemical”. For this reason, a lot of food research is concentrated on investigating commercially viable natural ingredients that have similar or better functional attributes than synthetic ones like dipotassium phosphate. In one embodiment, the stable compositions are free of dipotassium phosphate. Should the composition comprise a minor amount of dipotassium phosphate this amount is less than 0.1% by weight, for example, less than 0.05%, for example, less than 0.01%, for example, less than 0.005%, for example, less than 0.001%.

In one embodiment, the stable compositions are substantially free of citrus juice. Should the composition comprise a minor amount of citrus juice this amount is less than 0.1% by weight, for example, less than 0.05%, for example, less than 0.01%, for example, less than 0.005%, for example, less than 0.001%.

The stable compositions are typically in the form of an emulsion of vegetal oil droplets in an aqueous phase. The stable compositions described herein have a uniform distribution of particles within the aqueous phase, during shelf-life, for example during up to 30, 60 or 90, 120, 150, 180, 210 or 240 days storage at ambient (“room”) temperature, for example, from 15° C. to 25° C.

The stable compositions described herein have a particle size distribution having at least 90% particles with a maximum dimension equal to or less than 2 μm, including 1.9 μm, 1.8 μm, 1.7 μm, 1.6 μm, or 1.5 μm, for example, from 1.4 μm to 0.6 μm. In other embodiments, the stable compositions described herein have a particle size distribution having at least 50% particles with a maximum dimension equal to or less than 1 μm, for example, from 1 μm to 0.4 μm. In still other embodiments, the stable compositions described herein have a mean particle size of less than 2 μm, for example less than 1.5 μm, for example, less than 1.2 μm, for example, from 0.5 to 1.2 μm. Compositions with such particle size present excellent stability and whitening properties. Advantageously, the composition particle size is maintained during shelf-life, for example, during up to 30, 60 or 90, 120, 150, 180, 210 or 240 days storage at ambient (“room”) temperature, for example, from 15° C. to 25° C.

When the particle size of the composition exceeded having at least 90% particles with a dimension of greater than 2 μm, coalescence of the emulsion droplets was observed, leading to instability during ambient temperature storage.

In one embodiment the pH of the composition is at most 9.5, for example, from 7 to 9.5 or from 8.5 to 9.5.

### a) Water

The stable compositions disclosed herein comprise water. Water is typically present in an amount balancing the amounts of other ingredients to 100% by weight. In an embodiment water is present in an amount between 40% and 90% by weight, for example, or from 60% to 90%, or from 40% to 45% or from 45% to 50% or from 50% to 55% or from 55% to 60% or from 60% to 65% or from 65% to 70% or from 70% to 75%, or from 75% to 80% or from 80% to 85% or from 80% to 85%. In one embodiment the water quality is monitored to ensure a sufficiently low level of cations to ensure emulsification stability is not impacted. The total cation content can be from about 60 ppm (40 ppm for divalent ions and 20 ppm for monovalent ions) and the hardness of water can be 6 gram/gallon or less.

### b) Vegetal Oil

As used herein the term “vegetal” shall be taken to mean edible parts of a plant including but not limited to vegetables, fruits, flowers, stems, seeds, leaves and roots.

The stable compositions disclosed herein comprises at least one vegetal oil. Suitable examples of such oils include, but are not limited to, coconut oil, canola oil, soybean oil, sunflower oil, safflower oil, palm oil, palm kernel oil, olive oil, avocado oil and/or mixtures or combinations thereof. In certain embodiments, the oils are selected from the group consisting of coconut oil, palm oil, palm kernel oil, and/or mixtures or combinations thereof.

In one embodiment the vegetal oil is present in an amount of from 5% to 15% by weight, for example, from 7% to 12%, or from 8% to 10%, or from 7% to 9%, or from 8% to 9%, e.g., or from 8.5% to 8.9%. Compositions with such amounts of vegetal oil present good organoleptic and whitening properties.

Organoleptic properties are intended to include sensory properties of a given composition such as, but not limited to, mouthfeel, texture, taste, smell, visual appearance, consistency of the product and physical attributes of a substance that are considered pleasing to the individual.

### c) Plant Protein

The stable compositions described herein comprise at least one plant protein. In some embodiments, the plant protein source comprises or consists of legume, for example pulse or pulses. In other embodiments, the plant protein source are selected from the group consisting of lentils, chickpeas, peas, beans and/or combinations thereof. In still other embodiments, the plant protein sources are selected from the group consisting of yellow peas, green peas, split peas, field peas, dry peas, lentil, chickpeas/garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, lupin and/or mixtures or combinations thereof. In certain embodiments, the plant protein sources are faba, lentil and/or mixtures or combinations thereof.

Plant protein ingredients are known in the art and are commercially available. Plant protein ingredients can be, for example, a plant protein isolate, concentrate or flour.

The term “protein concentrate,” as used herein, generally refers to protein derived from plant source that has been extracted from the plant source and purified. Protein concentrate may comprise greater than or equal to about 40%, 50%, 60%, 70%, or 80%, or more total protein on a dry matter basis. The protein concentration of the protein concentrate may be increased by greater than or equal to about 20%, 30%, 40%, 50%, 60%, 70%, 80%, or more than the protein concentration of the plant. A protein concentrate may comprise a single type of protein or a combination of different types of proteins.

The term “protein isolate,” as used herein, generally refers to protein derived from a plant source that has been extracted from the plant source and purified. A protein isolate may have a higher purity than a protein concentrate. A protein isolate may be formed by further processing a protein concentrate to increase the protein concentration. Protein isolate may comprise greater than or equal to about 80%, 90%, 95%, or more protein on a dry matter basis.

In certain embodiments, the plant protein has not been subjected to a hydrolysis step.

In one embodiment, the stable compositions are substantially free of pea protein. In another embodiment, the stable compositions are free of pea protein. Should the stable composition comprise a minor amount of pea protein this amount is less than 0.1% by weight, for example, less than 0.05%, for example, less than 0.01%, for example, less than 0.005%, for example, less than 0.001%.

In one embodiment the plant protein is present in an amount of from 0.0001% to 5% by weight, for example, from 0.75% to 2.5%, or from 0.8% to 2%. For example, faba bean protein isolate having 90% protein content was found to work well from a range of from 1%, 1.4%, 1.5% and 2% in the stable compositions described herein. Similarly, lentil protein concentrate with a 55% protein content worked as well in the stable compositions. Surprisingly, pea protein isolate with a 90% protein content at 0.8% and 1.5% did not work well and the composition separated (not stable) at ambient conditions. This was surprising as pea protein is a commonly used protein isolate.

### d) Buffering Agents

The stable composition described herein comprise at least one buffering agent. Examples of such buffering agents include monophosphates, diphosphates, sodium mono- and bicarbonates, potassium mono- and bicarbonates, for example, potassium phosphate, dipotassium phosphate, potassium polyphosphates, sodium bicarbonate, trisodium citrate (also referred to as sodium citrate), sodium phosphate, disodium phosphate, trisodium phosphate and sodium polyphosphates, sodium bicarbonate, calcium carbonate and/or mixtures or combinations thereof.

The buffering agent can be provided in an amount sufficient to provide the pH of the composition of at most 9.5, for example, from 7 to 9.5 or from 8.5 to 9.5. Advantageously, the use of a buffering agent can contribute to product stability without impacting organoleptic properties and consumer perception. In one embodiment the buffering agent is present in an amount of from 0.0001% to 5% by weight, for example, from 0.2% to 1%.

### e) Optional Nut Base

The stable compositions described herein, optionally, can further comprise a nut composition which comprises nut matter and water. In one embodiment the nut matter is present in an amount of from 1% to 99% by weight, for example, from 10% to 98%.

Suitable examples of nuts include, but are not limited to, hazelnut, walnut, almond, cashew, peanut, chestnut, macadamia, pistachios, pecan and/or mixtures or combinations thereof. In one aspect, the nut composition is in the form of a butter, oil, margarine, paste or slurry.

In certain aspects, a nut+water “almond butter” having a total solids content of 15.77 can be used. Alternatively, an almond butter product having a 98% total solids content was also found to work.

Methods for the preparation of such nut composition are known in the art and typically comprise steps such as:

separation of a nutritive fraction of a plant, for example, separation of nut from a hull,

optionally a heat treatment of the nuts e.g. blanching or roasting,

mechanical disruption of the plant-matter and hydration and/or combination with an aqueous phase e.g. water.

In one embodiment, the optional nut composition is present in an amount of from 0.0001% to 10% by weight, for example, from 0.1% to 5%, or from 0.5% to 2%.

### f) Optional Hydrocolloid Agent

The stable compositions described herein can optionally include at least one hydrocolloid agent. Suitable examples include, but are not limited to, hydrocolloids, including xanthan gum, tragacanth, gum arabic, acacia gum or gellan gum. Such compounds are known in the art and are commercially available. Gellan gum can be, for example, a high acyl gellan.

Commercially, gellan gum is manufactured by inoculating a fermentation medium that contains a carbon source, such as glucose, phosphate and nitrogen sources, and appropriate trace elements with the micro-organism. After fermentation, the viscous broth is pasteurized and the direct recovery of polysaccharide by alcohol precipitation yields the substituted, high acyl content gellan gum. While low acylated gellan gum is obtained after treating the broth with alkali and then with alcohol precipitation. The degree of acylation is over 50% for high acyl form with two acyl substituents acetate at C6 and glycerate at C2 on the first glucose unit of the repeating unit of tetra saccharide, and on average, there is one glycerate per repeat and one acetate per every two repeats. While low acylated gellan gum is partly deacylated.

In certain embodiments the composition comprises a single hydrocolloid agent.

In one embodiment, the optional hydrocolloid is present in an amount of from 0.0001% to 1% by weight, for example, from 0.01% to 0.01%.

### g) Sweetening Ingredients

The stable compositions disclosed herein can optionally comprise at least one sweetening ingredient. Such an ingredient can contribute to the consumer perceived sweetness properties of the composition. It can also provide bulking properties to the composition. The sugar ingredient can be, for example, but not limited to, sucrose, fructose, saccharose, glucose, maltodextrin, dextrose, sorbitol, xylitol, or a mixture thereof. In one embodiment, the sweetener is a corn syrup, for example, a high fructose corn syrup, a corn syrup solid, cane sugar, beetroot sugar, honey, agave, maple syrup, or a mixture thereof. In another embodiment, it is a mixture of at least two of sucrose, fructose, saccharose, glucose, maltodextrin, dextrose, sorbitol, xylitol, a corn syrup, for example, a high fructose corn syrup, a corn syrup solid, cane sugar, beetroot sugar, honey, agave, maple syrup.

In one embodiment the sweetening ingredient is present in an amount of from 15% to 35% by weight. For example, the amount is from 15% to 20%, or from 20% to 25%, or from 25% to 30%, or from 25% to 30%, or from 30% to 35%.

### h) Optional Flavor Modification Agents

The stable compositions described herein optionally comprises flavor modification agent(s), different from the sweetening ingredient. These typically affect the taste of the composition, the amount thereof is usually determined according to taste that is desired. Examples can include salts, sweeteners, flavors, flavor modifiers, fruits and/or fruit extracts. Popular flavor modification agents, for example, include vanilla flavor or extract, dairy artificial flavor, hazelnut artificial flavor, amaretto, cinnamon, chocolate, caramel. Suitable ranges for an optional flavor modification agent are from 0.0001% to 5% w/w, e.g., from 0.05% to 3%, from 0.1% to 2%, etc. Examples of salts include sodium chloride, for example, sea salt. Sea salt can be added from 0.0001 to 2.5%, e.g., 0.05%.

### Packaging

The stable compositions described herein are typically packaged in a container. The container is then typically sealed, for example, with a cap and/or a flexible lid. The container can, for example, have a holding capacity or volume of up to 2 kg or 2 L, for example, up to 1.5 kg or 1.5 L, for example, up to 1.0 kg or 1.0 L, for example, up to 500 g or 500 mL, for example, up to 250 g or 250 mL, for example, up to 125 g or 125 mL, for example, up to 100 g or 100 mL, for example, up to 50 g or 50 mL, for example, up to 25 g or 25 mL. The container might provide one or several servings. Containers of up 250 g or 250 mL, preferably up to 100 g or 100 mL, typically provide a single serving. The container can be a bottle or a cup, for example, a plastic thermoformed cup. The sealing can be provided by a flexible lid and/or or a plastic cap. The flexible lid can be, for example, thermosealed to or on the opening of the bottle or cup. The container can be a small single cup, for example, of from 5 g or 5 mL to 15 g or 15 mL, and, for example, sealed with a flexible lid. Such small single cups can be offered alone or grouped in a secondary packaging.

The stable compositions described herein in the container can be stored, transported and/or distributed at a chilled temperature of 0° C. to 10° C., or at ambient (“room”) temperature, for example, from 15° C. to 25° C.

In various embodiments disclosed herein, the compositions are free from additional additives selected from the group consisting of modified starches, hydrocolloids, emulsifiers, stabilizers and whitening agents and/or combinations or mixtures thereof.

### Processes for the Preparation of Plant-Based Liquid Creamer and/or Whitener Compositions

In a second aspect, the present embodiments provide processes for the preparation of plant based liquid creamers and/or whitener compositions.

Processes for preparing plant-based liquid creamer compositions comprise the steps:

i) providing an aqueous mixture comprising components a), b), c), d) and optionally e), f), g) and/or optionally h);

ii) emulsifying the aqueous mixture;

iii) heat treating the aqueous mixture;

iv) emulsifying the heat treated aqueous mixture to provide a liquid creamer composition; and

v) optionally packaging the liquid creamer composition.

The heat treatment iii), can be carried out by pasteurization, sterilization and/or ultra-high temperature treatments (UHT). The heat treatment can be a direct heat treatment or an indirect heat treatment. UHT treatment is a process for preserving liquid beverages by exposing it to a brief, intense heating, normally to temperatures in the range of 135-145° C. for few seconds. This kills micro-organisms which would otherwise destroy the products. UHT treatment is a continuous process which takes place in a closed system. The product passes through heating and cooling stages. UHT processing can be used in conjunction with aseptic filling, to avoid re-contamination with microbes. Two common methods of UHT treatment are commonly used: (1) Indirect heating and cooling in heat exchangers, (2) Direct heating by steam injection or infusion of milk into steam and cooling by expansion under vacuum.

In certain aspects, the heat treatment iii) is under UHT and is carried out for less than 20 seconds and the mixture is heated to a final temperature of at least 140° C.

The emulsification can be carried out by means of homogenization. The homogenization can be a single step homogenization or a double step homogenization. The homogenization pressure may be adjusted to provide a liquid creamer composition having a particle size distribution having at least 90% or more particles with a maximum dimension equal to or less than 2 μm.

The process can optionally comprises a step v) for the packaging of the liquid creamer composition. The packaging can involve a step of dosing the composition in a container, and then sealing, for example, according to aseptic processing or Extended Shelf Life processing.

### Process of Use

The stable compositions described herein can be used in a process of creaming or whitening a beverage. The process typically comprises the step of mixing the stable compositions described herein with a beverage. Upon mixing, the composition disperses in the beverage, thereby modifying its taste and/or mouth feel, and whitens the beverage.

The beverage can be, for example, a coffee, tea, chocolate or fruit beverage. Such beverages comprise corresponding components, extracts and/or flavors.

In one embodiment the beverage is a hot beverage. The stable composition is typically mixed into the hot beverage at chilled temperature or at ambient temperature.

In one embodiment, at least 2 parts by weight, for example, at least 3 parts, for example, at least 4 parts, for example, at least 5 parts, of the beverage are mixed with 1 part by weight of the composition. In another embodiment, the container is a single serve container and all or part of the stable composition of the container is mixed with the beverage.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The following paragraphs enumerated consecutively from 1 through 20 provide for various aspects of the present embodiments. In one embodiment, in a first paragraph (1), the present invention provides a plant-based liquid creamer and/or whitener composition comprising:

a) 40-90% w/w water;

b) 5-15% w/w a vegetal oil;

c) 0.0001-5% w/w a plant protein; and

d) 0.0001%-5% w/w a buffering agent;

e) optionally, 0-5% w/w a nut base composition;

f) optionally, 0-1% w/w a hydrocolloid agent;

g) optionally, 15-35% w/w a sweetening agent;

h) optionally, 0.0001% to 5% w/w a flavor modification agent,

wherein the particle size particle size distribution of the composition has at least 90% or greater, particles with a maximum dimension equal to or less than 2 μm.

2. The creamer composition according to paragraph 1, wherein the particle size distribution is maintained after 30 days storage at 15° C. to 25° C.

3. The creamer composition according to either paragraph 1 or 2, wherein the composition is free from additional additives selected from the group consisting of modified starches, hydrocolloids, emulsifiers, stabilizers and whitening agents and/or combinations thereof.

4. The creamer composition according to any of paragraphs 1 through 3, wherein the vegetal oil comprises coconut oil, palm oil and/or combinations thereof.

5. The creamer composition according to any of paragraphs 1 through 4, wherein the nut base composition comprises 10% to 98% nut matter.

6. The creamer composition according to any of paragraphs 1 through 5, wherein the plant protein is a pulse protein.

7. The creamer composition according to any of paragraphs 1 through 6, wherein the plant protein is not pea protein.

8. The creamer composition according to any of paragraphs 1 through 7, wherein the stabilizing agent is a single agent selected from the group consisting of gellan gum, guar gum and acacia gum.

9. The creamer composition according to any of paragraphs 1 through 8, wherein the buffering agent is sodium bicarbonate.

10. The creamer composition according to any of paragraphs 1 through 9, having a pH of 7-9.5.

11. A process for preparing a plant-based liquid creamer composition comprising:

i) providing an aqueous mixture comprising components a), b), c), d) and optionally e), f), g) and/or optionally h) according to paragraph 1;

ii) emulsifying the aqueous mixture;

iii) heat treating the aqueous mixture;

iv) emulsifying the aqueous mixture to provide a liquid creamer composition; and

v) optionally packaging the liquid creamer composition.

12. The process according to paragraph 11, whereby in step iii) the heat treatment is for less than 20 seconds and the mixture is heated to a final temperature of at least 135° C. to 145° C.

13. The process according to either paragraph 11 or 12, wherein the emulsification is carried out by means of homogenization.

14. The method according to to any of paragraphs 11 through 13, wherein the homogenization pressure is adjusted to provide a liquid creamer composition having a particle size distribution with at least at least 90% or greater, particles having a maximum dimension equal to or less than 2 μm.

15. A plant-based liquid creamer and/or whitener composition comprising:

a) 40-90% w/w water;

5-15% w/w a vegetal oil;

0.0001-5% w/w a plant protein; and

0.0001%-5% w/w a buffering agent;

0.1-5% w/w a nut base composition; and/or

0.1-1% w/w a hydrocolloid agent; and/or

15-35% w/w a sweetening agent; and/or

0.0001% to 5% w/w a flavor modification agent,

wherein the particle size particle size distribution of the composition has at least 90% or greater, particles with a maximum dimension equal to or less than 2 μm.

16. The plant-based liquid creamer and/or whitener composition according to paragraph 15, wherein the nut base composition is present from about 0.5 to about 4% w/w.

17. The plant-based liquid creamer and/or whitener composition according to paragraph 15, wherein the hydrocolloid agent is present from about 0.2 to about 0.8% w/w.

18. The plant-based liquid creamer and/or whitener composition according to paragraph 15, wherein the sweetening agent is present from about 17 to about 25% w/w.

19. The plant-based liquid creamer and/or whitener composition according to paragraph 15, wherein the flavor modification agent is present from about 0.1% to 5% w/w.

20. The plant-based liquid creamer and/or whitener composition according to paragraph 15, wherein the nut base composition is present from about 0.5 to about 4% w/w, the hydrocolloid agent is present from about 0.2 to about 0.8% w/w, the sweetening agent is present from about 15 to about 25% w/w and the flavor modification agent is present from about 0.1% to 5% w/w.

[symbol]

Generally, the stable compositions (emulsions) described herein can be prepared as follows. The components are mixed together with water up to 100% weight to form a liquid mixture. The liquid mixture is homogenized (3000 psi first stage and 500 psi second stage), direct heat treated for 3 seconds to 20 seconds at 135° C. to 145° C. and homogenized a second time (2000 psi first stage and 500 psi second stage) before being aseptically packaged.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

The invention will be further illustrated by the following non-limiting Figures and Examples.

### EXAMPLES

### Example 1: Preparation of a Shelf-Stable Liquid Creamer

Liquid plant-based creamers were prepared as below.

A liquid mixture was prepared by mixing together the ingredients as listed in Table 1 together with water up to 100% weight. The liquid mix was homogenized using a two stage homogenization process (3000 psi for first stage and 500 psi for second stage), direct UHT heat treated (135° C. to 145° C. for 3-10 seconds) and homogenized in an aseptic homogeniser using a two stage homogenization process (2000 psi for first stage and 500 psi for second stage) a second time before being aseptically packaged.

TABLE 1

| % weight | Ingredient |
|---|---|
| 9.0 | Coconut oil |
| 4.0 | Almond base ((ground almonds (26.5% |
| | on dry matter basis) + water)) |
| 1.48 | Faba bean protein isolate |
| 0.03 | Gellan gum |
| 0.5 | Sodium bicarbonate |

| | Dx (10) | Dx (50) | Dx (90) | D [4, 3] | |
|---|---|---|---|---|---|
| | (μm) or | (μm) or | (μm) or | (μm) or | Specific |
| | 10% of the | 50% of the | 90% of the | Volume | Surface |
| | particles | particles | particles | weighted | Area |
| Sample Name | under | under | under | mean | (m²/kg) |
| Example 1 | 0.297 | 0.515 | 0.917 | 0.57 | 12630 |

### Example 2A: Preparation of a Shelf-Stable Liquid Creamer Using Slow Heat Treatment

Liquid plant-based creamers were prepared in accordance with Example 1. Heat treatment was carried out with indirect UHT to a target temperature of 135-145° C. for 3-10 sec, with the following modifications:

A single homogenization was carried out and the mixture was heat treated by indirect UHT heat treatment for 3 seconds to 20 seconds at 135° C. to 145° C. The particle size in the product was approximately 40 microns and was considered unlikely to be stable during ambient shelf storage for a target of 210 days. In this example, the product was homogenized only once using a two stage homogenizer (2000 psi first stage and 500 psi second stage).

An upstream two-stage homogenization (3000 psi first stage and 500 psi second stage) and indirect UHT heat treatment for 3 seconds to 20 seconds at 135° C. to 145° C. were carried out. The particle size of the composition was acceptable (under 1.5 μm). After 2 months, the particles were non-uniform in size and unstable leading to coalescence.

### Example 2B: Preparation of a Shelf-Stable Liquid Creamer Using Direct UHT Heat Treatment

Liquid plant-based creamers were prepared in accordance with Example 1, heat treatment was carried out in direct UHT for 3 seconds to 10 seconds or less to a target temperature of 135-145° C. with the following modifications:

A single homogenization (2000 psi first stage and 500 psi second stage) was carried out and the mixture was heat treated. The particle size in the product was too large (over 10 μm) and considered unlikely to be stable during ambient shelf storage for the target of 210 days.

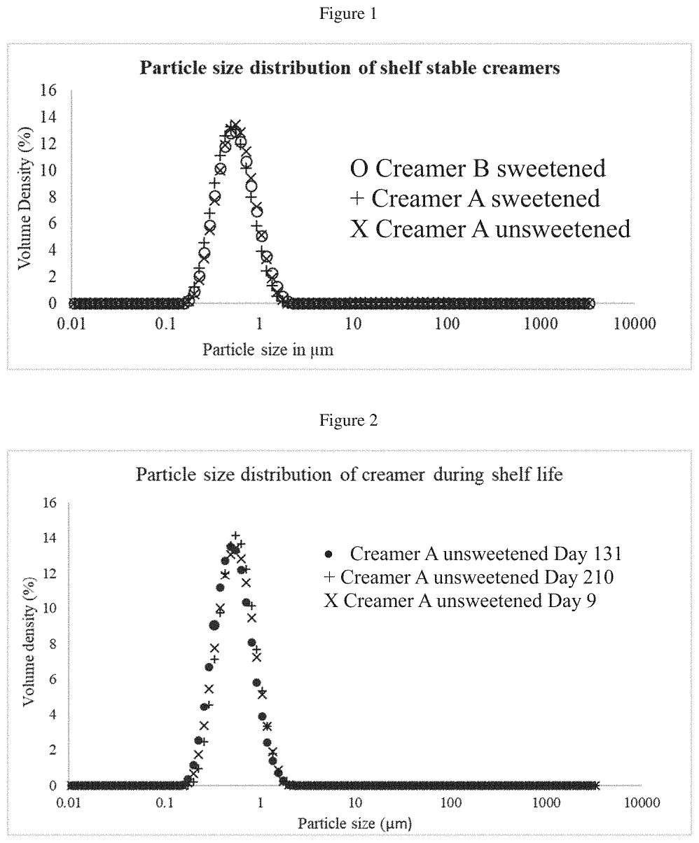

A double homogenization and direct UHT treatment were carried out as in Example 1. Particle size was acceptable (see Table 2A & FIG. 1). The first homogenization (3000 psi first stage and 500 psi second stage) was carried out before heat treatment and a second homogenization was carried out after heat treatment (2000 psi first stage and 500 psi second stage) After 240 days at ambient storage, the particles were stable and the product tested well in coffee.

TABLE 2

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) or | (m²/kg) |
| Average of | 0.318 | 0.553 | 0.978 | 0.608 | 11800 |
| ‘CREAMER | | | | | |
| PRODUCT | | | | | |
| FLAVOR A | | | | | |
| unsweetened’ | | | | | |
| Average of | 0.309 | 0.546 | 1.01 | 0.611 | 11970 |
| ‘CREAMER | | | | | |
| PRODUCT | | | | | |
| FLAVOR B | | | | | |
| Average of | 0.295 | 0.516 | 0.934 | 0.938 | 12590 |
| ‘CREAMER | | | | | |
| PRODUCT | | | | | |
| FLAVOR A | | | | | |
| sweetened’ | | | | | |

Flavoring was added at a level of 0.0001 to 5%, e.g., 0.45% or 0.5%. The flavors were added during batching process. The particle size profile of the creamer emulsions was characterized using a laser diffraction particle size analyzer called Mastersizer (Malvern Panalytical—Expert Scientific Instruments, USA).

The particle size profile of the creamer emulsions was characterized using a laser diffraction particle size analyzer. For all measurements, a refractive index of 1.333 was used for the aqueous phase and 1.449 for the oil (coconut oil) phase. The results of the particle size measurements are reported as volume weighted mean diameters D [4.3] and were based on an analysis of the measured angular light scattering pattern using Mie theory. The particle size distribution of these creamers shows a unimodal distribution throughout shelf life. More than 90% of the particles fall below a 1 μm with volume weighted mean ([D [4.3]) of under 1 μm. See Table 2A and FIG. 2 for data including size median and surface area of the particles over 210 days at ambient conditions.

TABLE 2A

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) | (m²/kg) |
| Creamer Product | 0.318 | 0.553 | 0.978 | 0.608 | 11800 |
| FLAVOR A | | | | | |
| unsweetened - | | | | | |
| Day 9 | | | | | |
| Creamer Product | 0.297 | 0.515 | 0.917 | 0.57 | 12630 |
| FLAVOR A | | | | | |
| unsweetened - | | | | | |
| Day 131 | | | | | |
| Creamer Product | 0.312 | 0.534 | 0.943 | 0.601 | 12130 |
| FLAVOR A | | | | | |
| unsweetened - | | | | | |
| 210 | | | | | |

### Example 3: Preparation of a Shelf-Stable Liquid Creamer Using Lentil Protein

Liquid plant-based creamers were prepared as below.

A liquid mixture was prepared by mixing together the ingredients as listed in Table 3 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, product can be processed immediately without further delay or if there is any delay, cooling down to refrigeration temperatures are recommended to avoid microbial growth.

TABLE 3

| % weight | Ingredient |
|---|---|
| 9.0 | Coconut oil |
| 4.0 | Almond base ((ground almonds (26.5% |
| | protein on dry matter basis) + water)) |
| 1.8 | Lentil protein concentrate |
| 0.03 | Gellan gum |
| 0.5 | Sodium bicarbonate |

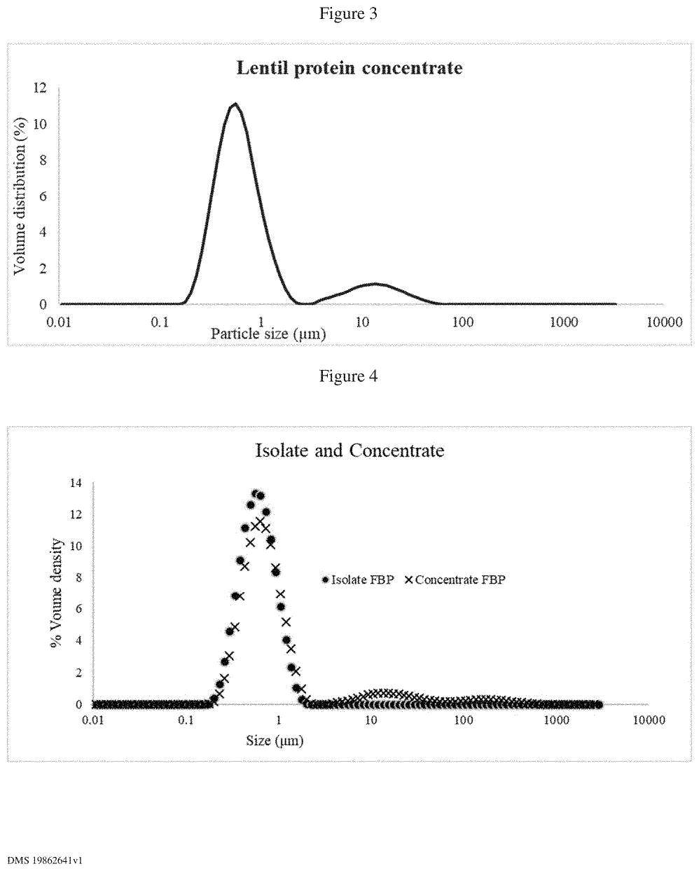

It was processed according to Example 2B and the particle size distribution appeared similar to Example 1. However, as noted in FIG. 3, a bimodal distribution was observed, however the bimodal distribution was absent when isolates were used. Based on these findings, it was concluded that the second mode is arising from the long chain carbohydrate (fibers) moiety present in the concentrate. Table 2C provides the particle size data.

TABLE 2C

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) | (m²/kg) |
| Example 3 | 0.327 | 0.616 | 6.96 | 2.43 | 10230 |
| Creamer with | | | | | |
| Lentil protein | | | | | |

Sensory attributes of Lentil protein isolates were significantly different than lentil concentrate and trials were centered around the lentil concentrate due to their superior flavor attributes. Whitening and turbidity aspects appeared to like that of Example 1.

### Example 4: Preparation of a Shelf-Stable Liquid Creamer Using Almond Base with Different Amounts of Almond

Liquid plant-based creamers were prepared as below.

A liquid mixture was prepared by mixing together the ingredients as listed in Tables 4 and 5 together with water up to 100% weight. The liquid mixture was homogenized, direct UHT heat treated and homogenized a second time before being aseptically packaged. A first homogenization (3000 psi first stage and 500 psi second stage) was carried out before heat treatment and a second homogenization was carried after heat treatment ((2000 psi first stage and 500 psi second stage). After the first homogenization, the product can be processed immediately without further delay or if there is any delay, cooling down to refrigeration temperatures are recommended to avoid microbial growth.

TABLE 4
Formula containing high levels of almond base

| % weight | Ingredient |
|---|---|
| 9.0 | Coconut oil |
| 8.0 | Almond base ((ground almonds (26.5% |
| | protein on dry matter basis) + water)) |
| 1.48 | Faba bean isolate |
| 0.03 | Gellan gum |
| 0.5 | Sodium bicarbonate |

TABLE 5
Formula containing low levels of almond base

| % weight | Ingredient |
|---|---|
| 9.0 | Coconut oil |
| 1.5 | Almond base ((ground almonds (26.5% |
| | protein on dry matter basis) + water)) |
| 1.48 | Faba bean isolate |
| 0.03 | Gellan gum |
| 0.5 | Sodium bicarbonate |

The almond base/almond milk used for processing had a particle size of 100 microns and its fibres were removed by filtration. Most almond butter comes with fibres (higher particle size). The process worked well for almond butters too. However a bimodal distribution was noted.

The samples based on Tables 4 and 5 were processed according to Example 2B and the particle size distribution is provided below with D [4.3] values under 1.5 μm.

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) | (m²/kg) |
| Creamer with | 0.408 | 0.937 | 2.45 | 1.22 | 7645 |
| high almond | | | | | |
| base | | | | | |
| Creamer with | 0.332 | 0.602 | 1.1 | 0.667 | 11000 |
| low almond base | | | | | |

The Example from Table 5 with low almond content produced a lower nutty flavor and lacked a creamy mouthfeel.

### Example 5: Preparation of a Shelf-Stable Liquid Creamer Using Different Amounts of Coconut Oil

Liquid plant-based creamers were prepared as below.

A liquid mixture was prepared by mixing together the ingredients as listed in Table 6 together with water up to 100% weight. The liquid mixture was homogenized, direct UHT heat treated and homogenized a second time before being aseptically packaged. The first homogenization (3000 psi first stage and 500 psi second stage) was carried out before the heat treatment and the second homogenization was carried after heat treatment (2000 psi first stage and 500 psi second stage). After first homogenization, the product can be processed immediately without further delay or if there is any delay, cooling down to refrigeration temperatures are recommended to avoid microbial growth.

TABLE 6
Formula containing low levels of coconut oil

| % weight | Ingredient |
|---|---|
| 5.0 | Coconut oil |
| 2.9 | Almond base (ground almonds + water) |
| 1.3 | Faba Bean Protein concentrate |
| 0.03 | Gellan gum |
| 0.5 | Sodium bicarbonate |

The almond base/almond milk used for processing had a particle size of 100 microns and its fibres were removed by filtration. Most almond butter comes with fibres (higher particle size). The process worked well for almond butters too. However a bimodal distribution was noted.

The mixture was processed according to Example 2B and the particle size distribution is given below. Although D [4.3] is 2 μm the creamer was stable at room temperature with no serum separation. However it had a lower whitening compared to Example 1.

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) | (m²/kg) |
| creamer | 0.364 | 0.665 | 1.43 | 2 | 9638 |
| containing | | | | | |
| 5% oil | | | | | |

In another example, coconut oil was replaced with equal amounts of sunflower oil. However that emulsion had inferior sensory properties during shelf life which was most probably attributed to lipid oxidation.

### Example 6: Preparation of a Shelf-Stable Liquid Creamer Using a Combination of Isolates and Concentrates

Liquid plant-based creamers were prepared as below.

A liquid mixture was prepared by mixing together the ingredients as listed in Table 7 together with water up to 100% weight. The liquid mixture was homogenized, direct UHT heat treated and homogenized a second time before being aseptically packaged. The first homogenization (3000 psi first stage and 500 psi second stage) was carried out before heat treatment and the second homogenization was carried after heat treatment (2000 psi first stage and 500 psi second stage). After the first homogenization, the product can be processed immediately without further delay or if there is any delay, cooling down to refrigeration temperatures are recommended to avoid microbial growth.

TABLE 7
Formula containing low levels of coconut oil

| % weight | Ingredient |
|---|---|
| 9.0 | Coconut oil |
| 2.9 | Almond base (ground almonds + water) |
| 0.753 | Faba Bean Protein concentrate |
| 0.753 | Faba bean Protein isolate |
| 0.03 | Gellan gum |
| 0.5 | Sodium bicarbonate |

The mixture was processed according to Example 2B and the particle size distribution appeared similar.

A bimodal distribution was observed for this emulsion. However, this bimodal distribution was absent when isolates were used (See FIG. 4 and Table 7A). Based on these findings, it was concluded that the second mode is arising from the long chain carbohydrate (fibers) moiety present in the concentrate. A high D90 and D [4.3] were obtained when concentrates were using that can be attributed to the long fibrous carbohydrate or other impurities present in the concentrates.

TABLE 7A

| | | | | | Specific |
|---|---|---|---|---|---|
| | | | | | Surface |
| | Dx (10) | Dx (50) | Dx (90) | D [4, 3] | Area |
| Sample Name | (μm) | (μm) | (μm) | (μm) | (m²/kg) |
| Average of ‘FBP | 0.334 | 0.583 | 1.03 | 0.639 | 11210 |
| Isolate’ | | | | | |
| Average of ‘FBP | 0.369 | 0.684 | 5.66 | 7.44 | 9247 |
| concentrate’ | | | | | |

The emulsion based on Table 7 has similar sensory and whitening aspects of Example 1.

### Example 7: Preparation of a Liquid Creamer Using Pea Protein

Liquid plant-based creamers were prepared as below.

A liquid mixture was prepared by mixing together the ingredients as listed in Table 8 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, the product can be processed immediately without further delay or if there is any delay, cooling down to refrigeration temperatures are recommended to avoid microbial growth.

TABLE 8

| % weight | Ingredient |
|---|---|
| 6.0 | Coconut oil |
| 4.0 | Almond base (ground almonds + water) |
| 0.8 | Pea protein concentrate |
| 0.12 | Sunflower lecithin |
| 0.06 | Xanthan gum |
| 0.036 | Gellan gum |
| 1.12 | Sodium bicarbonate/potassium |
| | citrate mixture (ICL specialties) |

It was processed according to Example 2B and showed separation at ambient temperature storage after 24 hours.

### Example 8: Preparation of a Liquid Creamer Using Acacia Gum

Liquid plant-based creamers were prepared as below.

A liquid mixture was prepared by mixing together the ingredients as listed in Table 9 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, the product can be processed immediately without further delay or if there is any delay, cooling down to refrigeration temperatures are recommended to avoid microbial growth.

TABLE 9

| % weight | Ingredient |
|---|---|
| 9.0 | Coconut oil |
| 4.0 | Almond base (ground almonds + water) |
| 0.5-5.4 | Acacia gum |
| 0.036 | Gellan gum |

Various levels of Acacia gum (0.5-5.4%) were used for the examples. No buffering agents were used as acacia was stable at the pH levels were it is added to coffee. They were processed according to Example 2B and the creamer showed visible separation at ambient temperature storage after 24 hours.

### Example 9: Preparation of a Liquid Creamer Using Pea Protein

Liquid plant-based creamers were prepared as below.

A liquid mixture was prepared by mixing together the ingredients as listed in Table 10 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, the product can be processed immediately without further delay or if there is any delay, cooling down to refrigeration temperatures are recommended to avoid microbial growth.

TABLE 10

| % weight | Ingredient |
|---|---|
| 9.0 | Coconut oil |
| 4.0 | Almond base (ground almonds + water) |
| 0.5-0.75 | Sunflower lecithin (Topocithin) or Sunlipon 50 |
| 0.036 | Gellan gum |
| 1.0 | dipotassium phosphate |

Two levels of lecithin (0.5 and 0.75%) were used in the examples. They were processed according to Example 2B and the creamer showed visible separation at ambient temperature storage after 24 hours.

### Example 10: Preparation of a Liquid Creamer Using Lecithin and Lentil Protein (Vitessence Pulse 2550)

Liquid plant-based creamers were prepared as below.

A liquid mixture was prepared by mixing together the ingredients as listed in Table 11 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, the product can be processed immediately without further delay or if there is any delay, cooling down to refrigeration temperatures are recommended to avoid microbial growth.

TABLE 11

| % weight | Ingredient |
|---|---|
| 9.0 | Coconut oil |
| 4.0 | Almond base (ground almonds + water) |
| 0.08 | Lecithin (Sunlipon 50) |
| 1.5 | Vitessence Pulse 2550 |
| 0.036 | Gellan gum |
| 1.0 | dipotassium phosphate |

The sample was processed according to Example 2B. The emulsion prepared based on Table 11 has similar whitening that of Example 1. Although the creamer was stable at room temperatures for 7 days, it showed visible separation at accelerated temperature storage at 40° C. for 7 days.

### Example 11: Preparation of a Liquid Creamer Using Lecithin and Faba Bean Protein Isolate

Liquid plant-based creamers were prepared as below.

A liquid mixture was prepared by mixing together the ingredients as listed in Table 12 together with water up to 100% weight. The liquid mixture was homogenized (3000 psi first stage and 500 psi second stage), direct UHT heat treated and homogenized a second time (2000 psi first stage and 500 psi second stage) before being aseptically packaged. After the first homogenization, the product can be processed immediately without further delay or if there is any delay, cooling down to refrigeration temperatures are recommended to avoid microbial growth.

TABLE 12

| % weight | Ingredient |
|---|---|
| 9.0 | Coconut oil |
| 4.0 | Almond base (ground almonds + water) |
| 0.12 | Sunflower lecithin |
| 0.7 | Faba bean protein 90C |
| 0.036 | Gellan gum |
| 0.04 | Xanthan gum |
| 1.0 | dipotassium phosphate |

The sample was processed according to Example 2B and the creamer showed visible separation at ambient temperature storage after 24 hours.

FBP isolate: 90% protein content

FBP concentrate: Faba 60% protein content

Gum Acacia, TIC Pretested from TIC gums and ISC Gums

Lentil protein concentrate: 55% protein content

Lecithin-Topocithin

Gellan Gum: High Acyl

Organic Coconut oil RBD: Ciranda

Sugar: Cargill

Almond milk: Various suppliers in USA

Pea protein isolate: from yellow peas

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A plant-based liquid creamer and/or whitener composition comprising:
a) 40-90% w/w water;
b) 5-15% w/w a vegetal oil;
c) 0.0001-5% w/w a plant protein; and
d) 0.0001%-5% w/w a buffering agent;
e) optionally, 0-5% w/w a nut base composition;
f) optionally, 0-1% w/w a hydrocolloid agent;
g) optionally, 15-35% w/w a sweetening agent;
h) optionally, 0.0001% to 5% w/w a flavor modification agent,
wherein the particle size particle size distribution of the composition has at least 90% or greater, particles with a maximum dimension equal to or less than 2 μm.

2. The creamer composition according to claim 1, wherein the particle size distribution is maintained after 30 days storage at 15° C. to 25° C.

3. The creamer composition according to claim 1, wherein the composition is free from additional additives selected from the group consisting of modified starches, hydrocolloids, emulsifiers, stabilizers and whitening agents and/or combinations thereof.

4. The creamer composition according to claim 1, wherein the vegetal oil comprises coconut oil, palm oil and/or combinations thereof.

5. The creamer composition according to claim 1, wherein the nut base composition comprises 10% to 98% nut matter.

6. The creamer composition according to claim 1, wherein the plant protein is a pulse protein.

7. The creamer composition according to claim 1, wherein the plant protein is not pea protein.

8. The creamer composition according to claim 1, wherein the stabilizing agent is a single agent selected from the group consisting of gellan gum, guar gum and acacia gum.

9. The creamer composition according to claim 1, wherein the buffering agent is sodium bicarbonate.

10. The creamer composition according to claim 1, having a pH of 7-9.5.

11. A process for preparing a plant-based liquid creamer composition comprising:
i) providing an aqueous mixture comprising components a), b), c), d) and optionally e), f), g) and/or optionally h) according to claim 1;
ii) emulsifying the aqueous mixture;
iii) heat treating the aqueous mixture;
iv) emulsifying the aqueous mixture to provide a liquid creamer composition; and
v) optionally packaging the liquid creamer composition.

12. The process according to claim 11, whereby in step iii) the heat treatment is for less than 20 seconds and the mixture is heated to a final temperature of at least 135° C.-145° C.

13. The process according to claim 11, wherein the emulsification is carried out by means of homogenization.

14. The method according to claim 13, wherein the homogenization pressure is adjusted to provide a liquid creamer composition having a particle size distribution with at least at least 90% or greater, particles having a maximum dimension equal to or less than 2 μm.

15. A plant-based liquid creamer and/or whitener composition comprising:
a) 40-90% w/w water;
i) 5-15% w/w a vegetal oil;
j) 0.0001-5% w/w a plant protein; and
k) 0.0001%-5% w/w a buffering agent;
l) 0.1-5% w/w a nut base composition; and/or
m) 0.1-1% w/w a hydrocolloid agent; and/or
n) 15-35% w/w a sweetening agent; and/or
o) 0.0001% to 5% w/w a flavor modification agent,
wherein the particle size particle size distribution of the composition has at least 90% or greater, particles with a maximum dimension equal to or less than 2 μm.

16. The plant-based liquid creamer and/or whitener composition according to claim 15, wherein the nut base composition is present from about 0.5 to about 4% w/w.

17. The plant-based liquid creamer and/or whitener composition according to claim 15, wherein the hydrocolloid agent is present from about 0.2 to about 0.8% w/w.

18. The plant-based liquid creamer and/or whitener composition according to claim 15, wherein the sweetening agent is present from about 17 to about 25% w/w.

19. The plant-based liquid creamer and/or whitener composition according to claim 15, wherein the flavor modification agent is present from about 0.1% to 5% w/w.

20. The plant-based liquid creamer and/or whitener composition according to claim 15, wherein the nut base composition is present from about 0.5 to about 4% w/w, the hydrocolloid agent is present from about 0.2 to about 0.8% w/w, the sweetening agent is present from about 15 to about 25% w/w and the flavor modification agent is present from about 0.1% to 5% w/w.
